(19) United States
(12) Patent Application Publication
(10) Pub. No.: US 2006/0157549 A1
(43) Pub. Date: Jul. 20, 2006

(54) Smart cards for automated sample analysis devices

(76) Inventor: Israel Mayer Stein, Chestnut Hill, MA (US)

Correspondence Address: Kenneth J. LuKacher;South Winton Court, Suite 204, 3136 Winton Road South, Rochester, NY, 14623, US

(21) Appl. No.: 11/035,530

(22) Filed: Jan. 14, 2005

(51) Int. Cl. G06F 17/00

(52) U.S. Cl. 235/375

(57) ABSTRACT

Cards having non-volatile memory, referred to as smart cards, are provided which are insertable into a slot of an automatic sample analysis device. Such smart cards may be of different types, including a quality control smart card, which stores quality control information for use by the device when analyzing quality control samples associated with the quality control smart card. Other types of smart card may also be provided, such as a setup card for setting up the device for operation, or a tube card for setting the device for a lot of sample containers.

### FIELD OF THE INVENTION

The present invention relates to cards having non-volatile memory, often referred to as smart cards, for use in automated devices for conducting analysis of samples, such as blood or other bodily fluid, from patients, in the practice of human or veterinary medicine, and relates particularly to, smart cards for use in maintaining quality control of automated analysis devices to assure their proper operation. Smart cards are also described relating to other operations of an automated sample analysis device, such as device set up, or setting the device for a lot of sample containers.

### BACKGROUND OF THE INVENTION

Medical laboratories utilize automated analysis devices for conducting testing of samples from patients. These devices can receive multiple test tubes containing samples, such as blood or other bodily fluids, and have a display and/or printer for outputting sample readings. For example one such test is erythrocyte sedimentation rate (ESR). Quality control samples are routinely loaded and run in these devices. The user manually compares the results of the readings from the quality control samples with acceptable ranges provided with such samples to determine if the device is working properly. These readings are often manually logged on a chart for future reference. Often two quality control samples are used, one normal and the other abnormal. Such quality control samples expire if not used by a certain date, and the acceptable ranges can vary from lot to lot of different samples. These controls are important, since without them there would be little confidence in the readings from such automated analysis devices, and often such control are required by regulatory agencies.

One problem is that quality control is user dependent in that sometimes the user may forget to perform necessary quality control, neglect or err in recording of results, use expired quality control samples, or err in determining when a quality control sample reading is in an acceptable range. This can result in inaccurate readings in patient samples due to failure to detect when the automated analysis devices are not working properly, and thus may cause improper patient care when physicians rely upon such readings. Thus, it would be desirable to provide a mechanism in automated analysis devices which assures that quality control samples are routinely run, automatically records quality control results, detects when such samples have expired, and detects when quality control readings are within or outside acceptable ranges.

### SUMMARY OF THE INVENTION

Accordingly, one object of the present invention is to provide smart cards which can store quality control information which can be read by an automated analysis device for use in maintaining quality control of such device in which user involvement is limited to loading quality control samples into the device.

It is another object of the present invention to provide an automated analysis device which can use smart cards that store quality control information use in maintaining quality control of the device.

It is a further object of the present invention to provide smart cards for use in an automated analysis device which records the resulting readings from analysis of quality control samples on the device.

It is still yet another object of the present invention to provide different types of smart cards for storing different types of information for use by an automated analysis device, such as for device set up, setting the device for a lot of sample containers, or quality control.

Another object of the present invention is to provide smart cards for an automated analysis device which detects when consumables or disposables, such as sample tubes or quality control samples, that have a limited shelf life and have expired.

It is yet another object of the present invention to provide smart cards which prevent their use with other automated analysis devices than those devices proper for use with such smart cards.

A further object of the present invention is to provide smart cards for automatic analysis device which can update parameters of device operation or the software used for operating the device.

Briefly described, smart cards are provided for use with a device for automated analysis of samples in which the device has at least one slot interfacing the device with one of such smart cards. Each smart card has memory and a connector for enabling a controller of the device to access the memory when the smart card is received in the device's slot. The memory stores at least quality control information associated with one or more quality control samples. When the smart card is received in the slot of the device, the controller accesses the memory to obtain the quality control information and uses the quality control information when any quality control samples associated with the smart card are analyzed by the device to assure proper device operation.

The automated analysis device may periodically perform quality control on quality control samples in accordance with quality control information read from the card. Records of the results of the analysis quality control samples may be stored in memory of the card by the device. The device uses the same quality control smart card until the expiration date of the lot(s) of quality control samples associated with the smart card or when the number of days of card use since insertion of the card in the device is exceeded, and will not operate upon samples unless a quality control card is inserted. The expiration date and number of days of use may represent part of the quality control information read by the device from the card. When the expiration date or number of days of use is exceed, the quality control card is replaced with a new quality control card and such quality control samples associated with the new card will be used. The removed quality control smart card represents an electronic quality control archive that may be sent to a central processing facility, so that the medical office or laboratory operating the analyzer may participate in a proficiency testing program. Such program may compare quality control results recorded on the card with results recorded by other devices. The device may also store in addition to records of analysis of quality control samples, a device identifier which identifies the model, serial number, and user of the device to associate quality control data recorded on the smart card with the device which recorded such data.

The present invention further embodies a method for maintaining quality control of a device for automated analysis of samples by the steps of: providing a smart card having memory storing quality control information for quality control samples; interfacing the smart card with the device to enable the device to access the memory; locating one or more quality control samples associated with the quality control information in the device; and utilizing the quality control information obtained from memory of the smart card when the one or more quality control samples are analyzed by the device to determine whether or not the device is properly operating.

The present invention also embodies a quality control kit for an automated sample analysis device having a lot of normal samples with a normal acceptable range, a lot of abnormal samples with an abnormal acceptable range, and a smart card having memory storing quality control information for such lots of normal and abnormal quality control samples in which the smart card is insertable in the device. The quality control information may represent the normal and abnormal acceptable ranges for the lots of normal and abnormal samples, the expiration date of the normal and abnormal samples, the number of days of use for the card, and the lot numbers associated with the lot of normal samples and lot of abnormal samples.

In addition, the present invention also relates to a system for using smart cards with a device for the automated analysis of samples. Such smart cards can be of different types to store different information relating to either the setup of the device at manufacture and/or at device installation at a laboratory or medical office, setting the device for a lot of sample containers, or quality control of the device in accordance with quality control samples. Information from each type of smart card is accessible to the device when the smart card is inserted into a slot having a connector interfacing the smart card with the device.

Smart cards relating to use of consumables or disposables of limited shelf life (e.g., cards relating to quality control samples, or sample containers) have an expiration date of such consumables or disposables as part of their stored information. The automated sample analysis device can use such information read from the cards to detect when such consumables or disposables exceed their shelf life.

Although smart card are referred to herein as cards having non-volatile memory, the smart cards may be any memory storage unit receivable in an automated analysis device having an interface to such unit, and thus are not limited to any particular form factor or shape.

### BRIEF DESCRIPTION OF THE DRAWINGS

The foregoing objects, features and advantages of the invention will become more apparent from a reading of the following description in connection with the accompanying drawings, in which:

FIG. 1 is example of an automated analyzer for samples having a housing into which multiple samples are receivable in test tubes;

FIG. 2 is partial broken view of the back of the analyzer of FIG. 1 showing a slot for insertion of a smart card;

FIG. 3 is an example of a block diagram of the analyzer of FIG. 1;

FIG. 4 is an example of a block diagram of a computer system for storing information on smart cards;

FIG. 5 is an example of a window on the display of the computer system of FIG. 4 for inputting quality control information onto a smart card;

FIG. 6 is a flow chart showing the operation of the analyzer for conducting quality control using information obtained from a quality control card; and

FIG. 7 is an example of a quality control record stored in memory of a quality control smart card outputted from a printer when coupled to analyzer of FIG. 1.

### DETAILED DESCRIPTION OF THE INVENTION

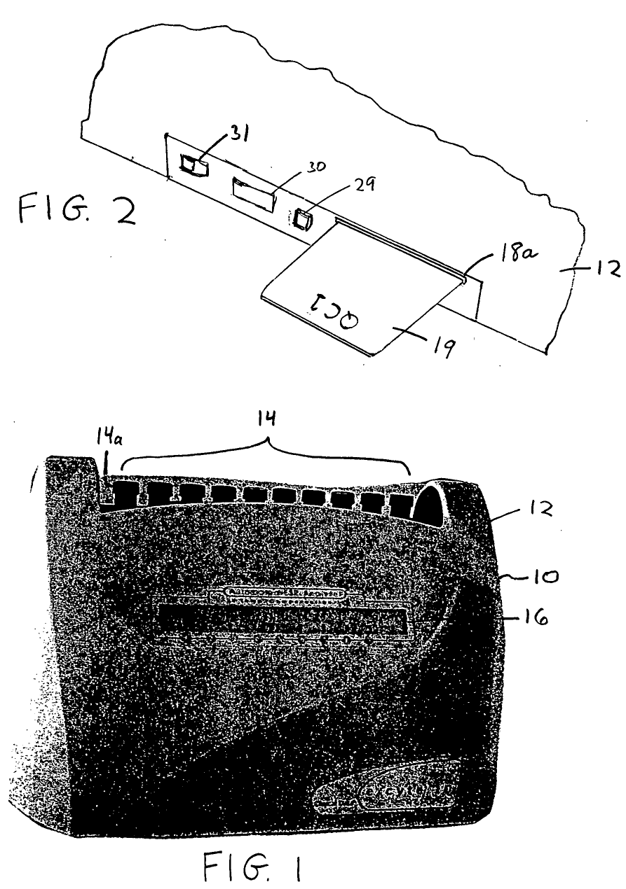

Referring to FIGS. 1 and 2, an automated sample analyzer (instrument or device) 10 is shown having a housing 12 with slots or channels 13 for sample receiving containers, such as test tubes 14. For example, ten channels may be provided for test tubes 14. Each test tube 14 has an attached stopper 14a. Typically, such stopper has a sealable passage through which a sample in inserted, via a needle, into the test tube. The analyzer housing 12 has a display 16 and a card slot opening 18a along the backside of housing 12 into which a smart card 19 is insertable.

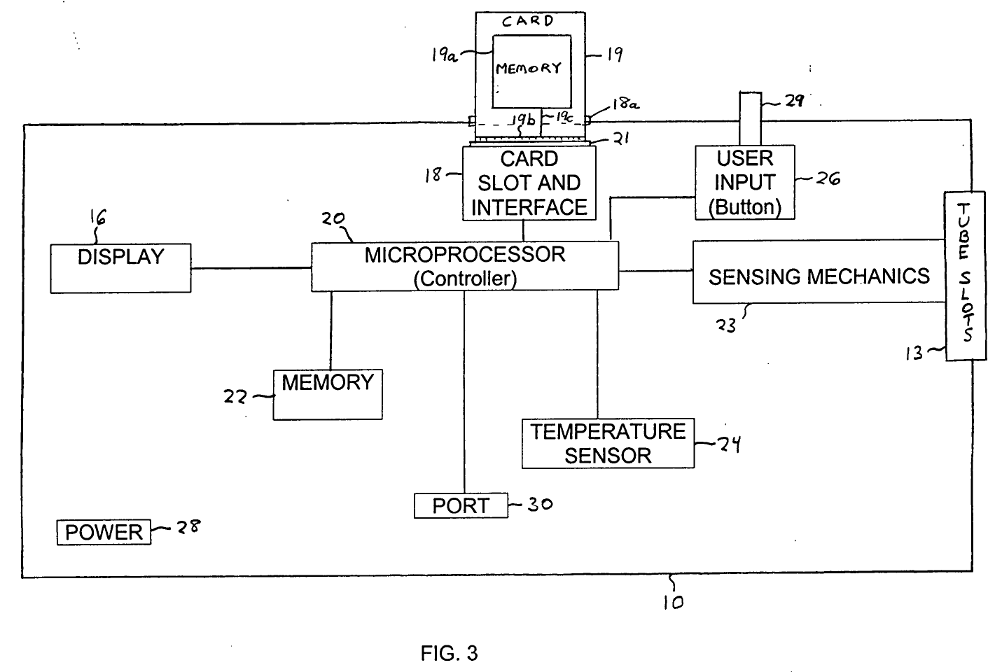

As shown in the block diagram of FIG. 3, the analyzer 10 has a microprocessor (or controller) 20 which operates in accordance with a program, which may be stored in memory 22 (e.g., ROM, RAM, EEPROM, FLASH, or the like, or a combination thereof). The microprocessor 20 can read and write data from smart card memory 19a when such card is inserted, via opening 18a, to a card slot and interface 18. Smart cards may be any type of electronic card having non-volatile memory, such as FLASH or EEPROM, and an edge connector 19b which can mate with a connector 21 of card slot and interface 18. The edge connector may have one or more contacts for coupling the microprocessor 20 to the memory of the card. Preferably the smart card is a card having a programmable IC chip, such as an SLE 4428 EEPROM manufactured by Siemens AG of Germany. For more information on this IC chip, write/read/erase operations, and data communication with the IC chip, see Siemens Data Sheet 04.94, ICs for Chip Cards SLE 4418/SLE 4428 Intelligent 8-Kbit EEPROM, Siemens AG, 1994.

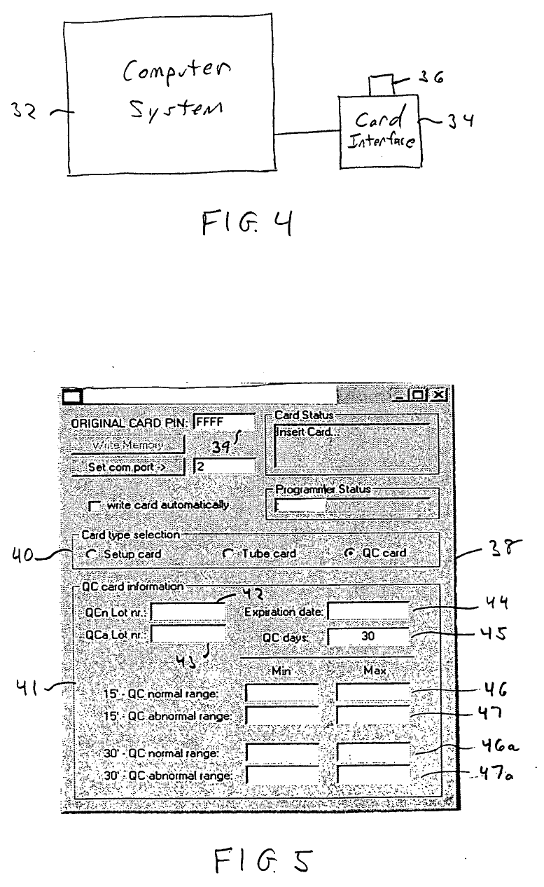

The commands and data used for reading/writing data on each smart card is in accordance with the IC memory chip on the card, such as in the example of SLE 4428. Wires or connections 19c on the card couple connector 19b to the card's memory 19a. Memory 19a is accessible to the microprocessor 20 via connector 21 to connector 19b (or to a computer system 32 when card is coupled to a connector of a card interface 34 of FIG. 4). Power (and ground) may also be supplied to memory 19a, via connector 21, or such may be provided by a battery on the card.

The above-described card electronics may be provided on a circuit board contained in a housing, such as of plastic or other material, of a rectangular card profile having connector 19a along one side, which is receivable in slot 18a to connector 21. Such circuit board may also be part of the housing, or represents a substrate embedded, coated, or other covered by material forming the card's housing. Other packaging of electronics of the smart card may also be used as typical of electronic memory cards. Smart card may also be of other profile or shape in accordance with the slot receiving the card.

A sensing mechanism 23 is provided for conducting the test on each of the samples in test tubes 14 and outputting test data to microprocessor 20, which then processes the test data into readings for output to display 16. The sensing mechanism 23 is controlled by the microprocessor 20 to start and time each test. For example, sensing mechanism 23 may have sensor(s) and motor(s) for moving samples and/or sensors in accordance with the particular test to be performed. Sensors may be, for example, photodetectors, CCD arrays, cameras, or the like, which can optically view a sample for taking optical measurements (or images) of a sample in a tube. The microprocessor 20 receives and processes test data from such sensor(s) and determines a reading for the sample, such reading may be based on a single measurement, or on multiple measurements over the time of the test. Also, such sensor(s) may be used for detecting the presence of a tube 14 in a given channel of the analyzer so as to inform the microprocessor to start the test.

Depending on the test to be performed, a temperature sensor 24 may be provided which may be read by the microprocessor 20 for any needed correction factor. The microprocessor may use curves, look-up-tables, equations, formulas, or the like, depending on the type of test of the particular analyzer in processing the raw output data from mechanism 23 into in useful readings. The particular mechanism 23 of the analyzer also depends on the particular test to be performed, as such, a detailed description of the mechanics is not provided therein as it varies from analyzer to analyzer. For example, the analyzer 23 may perform erythrocyte sedimentation rate (ESR) testing, and such an ESR analyzer is available from Clinical Data, Inc. of Newton, Mass., U.S.A. An ESR analyzer uses optical sensors to measure the rate as when sediment falls in a blood sample. The sensing mechanisms for ESR measurements may be as shown, for example, in U.S. Pat. Nos. 5,003,488, 6,506,606, 6,235,536, 5,914,272, or 5,745,227. Other automated sample analysis devices can perform other tests, such as cell counters, clinical chemistry analyzers, electrolyte analyzers, immunochemistry analyzers, blood coagulation analyzers, and other similar devices. As such, although the use of the invention is described for ESR analysis, the present invention may be adapted for any microprocessor, or computer controlled instrument, analyzer, device, or system which tests samples by adding a smart card slot and interface, and using smart cards as described below.

A display 16, such as an LCD display, on the housing 10 provides the user with instructions for operating the analyzer 10 and outputting results of tested samples. Such results may also be outputted, via a port 30, such as an RS232 port, to a printer or other output device. A user interface 26 may be provided along housing 12, such as button(s) or a keypad, to microprocessor 20. For example, a button 29 may provide the user interface 26. Display 16 may also be a touch screen display for enabling user interface 26. Although multiple communication lines are provided to I/O ports of microprocessor 20, other communication means may be used, such as a data bus, multiplexor, or other typical data communication architecture. If needed, analog-to-digital (A-D) converters may also be provided (when microprocessor 20 does not perform A-D conversion on-board) for converting analog signals from sensor(s) of mechanism 23 (or sensor 24) into digital signals to an input port of microprocessor 20. Power 28 may be supplied for operating electrical and mechanical components, such as by a battery in housing 12, or power supply receiving typical external AC voltage. A power on/off switch 31 may be used to control the power 28 from such battery or power supply. Other components may also be provided, such as audio means, such as audio generator circuit and speaker, providing audio signals (e.g., beep(s)) controlled by microprocessor 20. The microprocessor 20 also provides a clock maintaining the current date and time. The block diagram of FIG. 3 is intended to show the typical components of a microprocessor controlled automated sampler analyzer, in which the slot interface 18 of the present invention is provided along its housing having data communication capability with such microprocessor, as such, the invention is not limited to such components or architecture.

In operation, microprocessor 20 may use data from multiple types of smart cards. At initialization, set up information providing calibration and/or operating parameters may be stored in memory of a set-up smart card. The particular set up information needed depends on the particular automated analyzer 10 and test to be performed, setup information is useful for inputting variables or other parameters of operation for use by the microprocessor in controlling operation and determining readings from test data outputted from sensing mechanism 23. For example, the set up card may contain setup information, such as customerid, temperature corrections, working time for each test, and correction factors. However, other methods of inputting data into memory for use by microprocessor 20 may be used, such as via a programming port to the microprocessor along housing 12. Such information may alternatively be inputted via a user interface, such as a keypad and/or input button(s), via a menu input fields shown on display 16. The analyzer uses display 16 to provide instructions to the user to insert the setup card and/or manually input set up information. For example, time and date for resetting the analyzer's internal clock may be performed manually. Typically, the setup card is used once at the factory or upon installation of the analyzer 10 at a medical office or laboratory, such as during or after boot up of the analyzer's software by the microprocessor. Once loaded into the analyzer, the setup information is maintained in memory 22 available to the microprocessor 20 (and/or memory registers of the microprocessor). After setup is complete, the user is instructed on display 18 to remove the setup card and insert a tube card, as described below.

With each lot of test tubes for receiving samples, the analyzer may be provided with information about the lot, such lot information may include: a lot number; number of tubes in the lot; and the expiration date of the lot. This information may be inputted from memory of another type of smart card, called the tube card, when received in slot 18. Microprocessor 20 maintains a counter for each tube lot (referred to herein as the tube counter). Using the information from the tube card, the tube counter is reset by the microprocessor for each new tube lot to the number of tubes in the lot, and incremented for each sample run, excluding quality control samples, until one of the maximum numbers is exceeded or the expiration date of the lot is reached. At such time, the microprocessor prompts the user, via display 16, to use a new lot of sample test tube and a new tube card into slot 18. Such information may alternatively be inputted via a user interface, such as a keypad and/or input button(s), via a menu input fields shown on display 16. After the tube card information is read, the user is instructed to remove this card and insert a quality control card, as described below.

In order to maintain quality control for analyzer 10, quality control samples are run after setup, and then periodically thereafter, such as once at the start of each day. The quality control samples are often provided in a kit, which includes a set of normal samples and abnormal samples. Such kit is also provided with a quality control (QC) smart card 19 which is associated with the samples in the kit and stores QC information for such samples. The samples are provided in test tubes similar to those used for patient samples in the analyzer 10. The kit may contain multiples QC cards, such as twelve for a 12-month period, each with their associated normal and abnormal samples.

The information stored on the QC card, as well as the set up card and tube card, may be inputted via a card read/write interface or device to a computer system, such as a personal computer or laptop having a display and input means, such as keyboard, and/or mouse/track pad or the like. FIG. 4 is a block diagram of such a card writer computer system 32 for programming a smart card 36 having a card interface 34 capable of reading and writing data to memory of the smart card, so that such card is readable (and writable if needed) by microprocessor 20. Such card interface 34 may be similar to interface 18, and have a connector and slot similar to connector 21 and slot 18a, respectively. If necessary, such computer system 32 may also organize the memory of smart card 36 for read/write by computer system 32 and microprocessor 20. Alternatively, interface 34 may be provided within the computer system 32. Programs for reading/writing to the smart card may be window-based for inputting desired information. Information may be stored in memory of each smart card in a data structure having multiple data fields, but other data structures may be used.

For the case of a smart card storing quality control information, an example of such a window in shown in FIG. 5. Buttons in box 40 selects smart card type. When QC card is so selected, box 41 is provided with data field for entry of quality control information. For example, such data fields may include: the lot number of the normal samples 42; the lot number of the abnormal samples 43; the expiration date of those lots 44; a number of days 45 represents the number of days the quality control card (or kit) should be used; minimum and maximum readings of a normal sample (i.e., normal acceptable range) 46; minimum and maximum ranges for an abnormal sample (i.e., abnormal acceptable range) 47. The values which may be expected at two different reading times from start of the test are shown from abnormal and normal samples, one at 15 minute, and the other at 30 minutes. Accordingly, data fields 46 and 47 apply to normal and abnormal acceptable ranges for 15 minutes, and data fields 46a and 47a apply to normal and abnormal acceptable ranges for 30 minutes. Additional, or other time values from the start of each test, may be used. At set up, the analyzer was set to the particular working time, and as such, the microprocessor 20 when processing test data from quality control samples, may use only the working time corresponding to that of the setup working time. Other data fields that may be stored include: temperature correction, mechanical range calibration, and results correction factor, for use the analyzer when running the quality control samples. Optionally, the data field having the number of days 45 may instead provide entry of a number of samples of one of the normal or abnormal lot in the kit to accompany the QC card, and such data field is titled accordingly (typically a kit contain the same number of both lots). Similarly, selection of card type in box 40 for set up or tube card would provide a window 41 with data field for entry of information described earlier for set-up and tube cards, respectively.

Other data fields may be provided on the QC card, such as, for example: identifying the format of the information stored on the card; card type with a number or code identifying the type of card (e.g., tube, QC, or set up) selected at box 40; card manufacturer; a checksum value for error detection; value or identifier of the type or model of analyzer for use with the card; card expiration date; and date of last QC run date. Such data fields may also be entered via window 41 (or another window) by use of appropriate data fields on the screen. By data in card type and/or format fields, the analyzer can read data stored in memory 19a, where each type of card may have a different unique set of data fields. One or more data field failing to have an entry, or values outside expected range(s), would indicate an invalid or wrong type of card is inserted. Other or different data fields of smart cards may also be used.

When each smart card is written, the card writer associates that smart card with a PIN number (or identifier) associated with the type or model of analyzer to be used with that card by storing the PIN number in a PIN number data field. This PIN number may be one of the data fields when the card is written, such in data field 39 of FIG. 5. When a smart card is first inserted in the analyzer, the microprocessor reads the PIN number from a smart card and compares the read PIN number with a stored PIN number in memory of the analyzer. Such PIN number is stored in memory 22 of the analyzer when manufactured, or via input from the set up card when read. Only if the read PIN number matches that stored in analyzer memory will the information from the card be used by the microprocessor. Use of the PIN number assures that the correct smart card is used with the proper analyzer, and thus prevents smart card use with other types or models automated analysis devices than those proper for use with such smart card.

By assuring the smart card is used with the proper type or model of analyzer avoids use of consumables or disposables (e.g., sample tubes, or quality control samples) that are not proper for the analyzer. For example, each tube card is associated with certain sample tubes by the tubes associated being provided along with the tube card. Thus, if the PIN number of a tube card inserted in the analyzer does not match the PIN number stored in the analyzer, the user is aware that the tubes associated with that tube card are not proper for the analyzer. In another example, each QC card is associated with certain quality control samples by the quality control samples provided along with the QC card (such as in the QC kit). Thus, if the PIN number of a QC card inserted in the analyzer does not match the PIN number stored in the analyzer, the user is aware that the quality control samples associated with that QC card are not proper for the analyzer. This is especially useful when smart cards are used in a laboratory or small medical/physician office having different types or models automated analyzers.

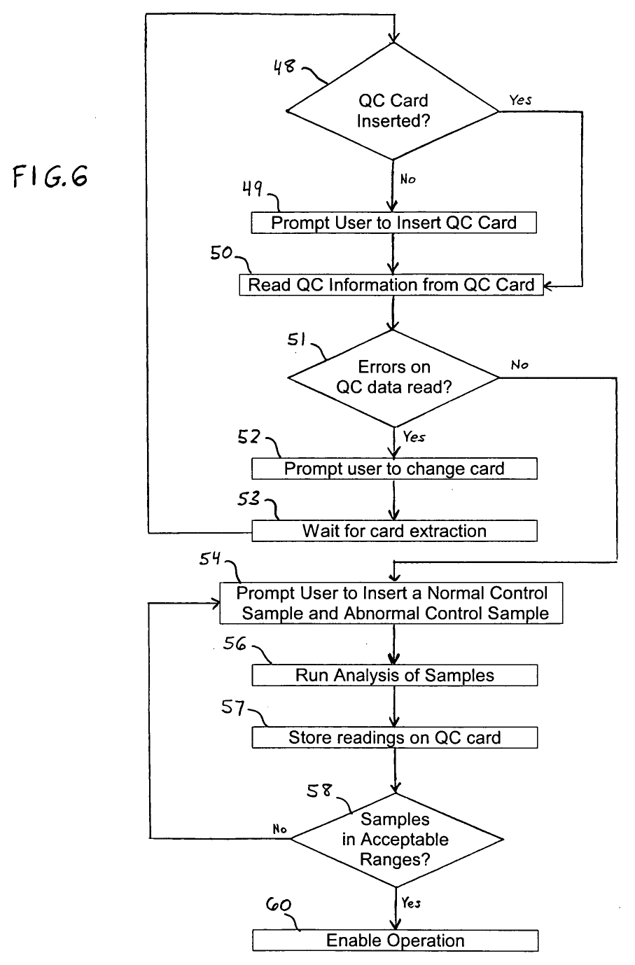

The process for running QC samples is shown in FIG. 6. The microprocessor first checks if the QC card is present in slot 18 (step 48). This can be done by checking the status of connector(s) of interface 18, or by attempting to read card information. If not, the microprocessor 20 prompts the user, via display 16, with an instruction to insert a QC card (step 49). The microprocessor reads the QC information from the QC card (step 50), and checks for errors in the data read from the card (step 51). If errors are detected, the user is prompted, via display 16, to change the QC card (step 52), and the microprocessor waits for card extraction (step 53) prior to returning to step 48. Error checking at step 51 encompasses one or more of: determining if the PIN number read matches the PIN number stored in memory of the analyzer, determining errors in the format of data read, checksum error, or any other error in data reading. Reading at step 50 need only occur when the QC card is first inserted in slot 18 and read by the microprocessor 20, as the QC information is stored by the microprocessor in memory 22 or in memory (e.g., registers) of the microprocessor. Alternatively, the microprocessor need only check that the lots numbers of the normal and abnormal samples in memory of the QC card are same as stored in such memory, and if not, then reads the quality control information from the card.

Next, the user is prompted with an instruction on display 16 to insert two test tubes from the kit associated with the QC card with normal and abnormal samples in particular channels 13 (step 54), such as channels numbered one and two in the analyzer. One or more of the remaining channels may be unused or have test tubes with patient samples. The samples are then run (step 56), and the results for the normal and abnormal samples are stored in memory of the QC card with the current date from the internal clock (step 57). Once readings from the normal and abnormal samples are complete for one of the time values for the working time of the analyzer, such as 15 or 30 minutes, it is determined whether they are at or within their respective minimum and maximum readings from the quality control information associated with such working time. If so, the analyzer operation is enabled for normal running of patient samples (step 60), and the results of any samples in other channels are provided (e.g., scrolled) on display 16 as when the samples are normally run. If one or both normal and abnormal samples were outside of their respective ranges, the display 16 indicates “OUT”, and the user is prompted to repeat quality control test with different normal and abnormal samples from the kit (steps 56, 57, and 58). Each kit may contain additional samples than the number of days per the quality control information from the QC card in case such repeated QC runs are performed. Repeated QC testing which results in readings for one or both samples outside of their respective acceptable ranges indicates maintenance on the analyzer is required. At step 56, the microprocessor 20 overwrites the previous readings with the new readings each time the quality control test is rerun. If desired at step 60, sample readings may be checked against acceptable ranges for more than one of the working times (e.g., both 15 and 30 minutes) of the quality control information from the QC card. The recording of QC sample readings on the QC card automates the transcription of the data and eliminates the need for manual entry as if a paper form was used, as is now the convention.

Although not recommended, QC testing may be skipped for a day (or skip a repeat of QC testing) when the instruction for performing QC is provided on display 18 at step 54. When the button 29 provided along the back side of housing 12 (FIG. 2) is depressed for two seconds, a confirming audio signal, e.g., beep, is provided, and all channels are now available for patient samples. Thus, the user must manually inform the analyzer to skip a daily QC run (or repeated QC testing). When this occurs, a record may be added to memory of the QC card that QC was skipped for that day for both samples.

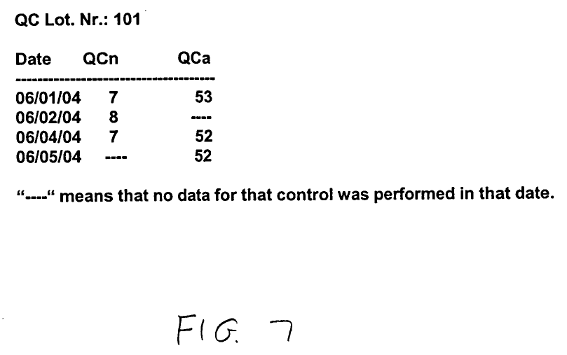

When no samples are being run, the analyzer may enter a standby mode until a test tube sample is detected by the sensing mechanism 23. When button 29 is depressed in a standby mode, and if a printer is coupled to port 30, the readings recorded on the QC card each day are outputted to the printer. An example of a printed output is shown in FIG. 7 for a period of four days in which the analyzer was in use, where QCn is the normal control reading, QCa is the abnormal control reading, and—that no control was performed for that date. If desired, the analyzer may be set up such that only one of the normal or abnormal samples need be run each day. If no printer is present, or in addition to such printing, the readings recorded in memory on the QC card may also be provided on display 16.

Each QC card has a device identifier data field which is null, empty (or zero) prior to insertion into the analyzer. When QC card is first written to, the microprocessor 20 stores the analyzer's device identifier, which is a unique number or code which identifies that analyzer and its user. The device identifier is stored in memory 22 of the analyzer, and may represent a combination of user, serial, or model number values or codes stored in the analyzer. For example, the device identifier may be a nine digit code including three parts: a user number (e.g., customerID read and stored earlier from the set up card), serial number of the analyzer, and model number of the analyzer. Optionally, the device identifier may include the user number and serial number, without the model number, where model number can be determined from the serial number of the analyzer. This is useful for associating quality control data recorded on the QC card with the device which recorded such data.

As stated earlier, the microprocessor prompts the user, via display 16, to use a new lot of sample test tubes and its associated new tube card in slot 18, when one of the maximum number of tubes is exceeded on the tube counter or the expiration date of the tube lot is reached. Such expiration date being stored in the analyzer's memory from the last tube card inserted. It may be necessary to remove the QC card present in slot 18 to insert the new tube card, and such QC card will be reinserted in the slot after information is read from the new tube card. When reinserted, the microprocessor 20 reads part of the QC information to assure that it is the same card which was removed, e.g., by verifying the PIN number, stored device identifier, or other information on the card matches that stored in memory of the analyzer.

A counter is provided in memory of the analyzer for storing the number of days of use (referred to herein as the QC counter). The QC counter is reset by microprocessor 20 when the microprocessor detects that a new QC card is inserted, such as the read QC card not having a stored device identifier in its memory. Other counters may also be provided in memory of the analyzer, such as a counter for indexing the number of normal samples run and a counter for indexing the number of abnormal samples run. These counters are also reset when a new QC card is inserted.

After normal operation is enabled at step 60, the QC card remains inserted in analyzer slot 18a. If the QC card is not detected (such as by checking the status of connector(s) of interface 18, or by attempting to read card information), the microprocessor 20 will continuously prompt the user to input a QC card in the analyzer 10, and if such card is not present in slot 18a the analyzer will not operate upon patient samples. This avoids a user neglecting to run QC samples, unless the user expressly wishes to skip a QC daily run, as described earlier.

For each day a QC run in performed in the analyzer, the QC counter is indexed in the microprocessor. When the microprocessor detects that the QC counter exceeds the number of days, or the current date of its clock exceeds the expiration date, from the quality control information read from the QC card, the user is instructed on display 18 to insert a new QC card and thus the user will use a new QC samples which accompanies such QC card. Unless such new QC card is so inserted in slot 18, the analyzer will not operate upon patient samples. This assure that expired QC samples are not used, as well as the user does not use QC samples associated with another QC card. Optionally, a new QC card may also be required when the microprocessor detects that the number of normal and/or abnormal samples exceeds their respective counters, if such counters are utilized and QC information read also includes such number of samples associated with the QC card, or a new QC card may also be required when the current date its clock exceeds assigned date(s) stored in memory of the analyzer, such as the first of each month. These assigned card dates may be stored in the analyzer's memory at manufacture, or received via the set up card information. Thus, quality control smart cards improves quality control in which user involvement is limited to loading quality control samples into the analyzer, and unlike other sample analyzers, quality control functions are performed and recorded automatically in the analyzer.

When a QC card is replaced, the removed QC card may be stored as an electronic quality control archive record, or the removed QC card may be sent to a central processing facility so that the medical office or laboratory operating the analyzer may participate in a proficiency testing program, which may be required by various government regulatory agencies. Such a proficiency testing program compares the quality control results with other users of the same device on a monthly basis. The use of the smart card assures that data transmitted for proficiency testing is accurate. When read by the card reader of the computer system of the proficiency testing program, the device identifier stored on the QC card may be used to identify (or verify) the particular analyzer which recorded the QC sample results data on the card as well as the user of the analyzer. The computer system and card reader may be similar to computer system 32 and card interface 34 of FIG. 4.

The smart card may also be used to update or upgrade software which is used by the automated analyzer. These cards are specialized set up cards, but when read by the microprocessor 20, instruct the microprocessor to initiate a download of software from memory of the smart card into memory of the analyzer representing update or upgraded software. Updates may be, for example, parameters of device operation, while an upgrade may reconfigure all or part of the software operating the analyzer to improve testing, or otherwise modify analyzer operation or memory. Once installed in memory of the analyzer, the microprocessor will operate the analyzer in accordance with it updated or upgraded programming. The microprocessor may have a boot loader application program for carrying out the download and execution of software from the card to the analyzer's memory.

Other smart cards may also be used in a clinical chemistry analyzer, such as that describer earlier for ESR testing, or in other clinical chemistry analyzers or systems having a card interface for a smart card. One such smart card is referred to as an assay card, and stores information in its memory having data representing the number of tests the analyzer can perform. When inserted in the analyzer, a counter in the microprocessor is indexed to this number, and decremented for each test performed. For example, the counter may be set to 1,000 tests of one or more varieties that may be conducted on the analyzer. When the counter reaches zero, the analyzer prompts the user to insert a new assay card to reset the counter. When the assay card is read, the card's memory is erased by the analyzer's microprocessor, or such data fields storing the number of tests is set to zero, before the card is removed from the analyzer. This avoids reuse of the same assay card. The data on the assay card may be binary, and have security protection to prevent it from being copied, such as matching a unique code on the analyzer and card. The assay card may be used in an analyzer with or without the other smart cards described herein. Optionally, the counter is maintained in memory of the assay card, and the data storing the number of tests on the card is decremented by the microprocessor for each test performed by the analyzer until zero. The assay card may also identify the specific test or panel and the number of tests to be performed, rather than be generic for use of any test on the analyzer. For example, if a kit contains 250 tests of glucose, 250 tests of glucose are incremented by the card in the analyzer's counter when inserted. Such a card for each assay would also contain the lot number and expiration date of the tests in the kit. If an assay card is provided with each assay it may also contain the proper parameter setup for the analyzer for the assay to be performed.

Another smart card is referred to as a controls/calibrator card, and stores information in its memory having data representing the values for controls or calibrators for the analyzer, such as calibration curves or data. Controls or calibrators, for example, may be reagents or other control samples needed for calibrating the analyzer for proper operation. This card also has data representing the expiration date, lot number, or other values of the controls or calibrators. When inserted, data on the controls/calibrator card is read and stored in the analyzer's memory for use by the analyzer when calibration is performed using the controls or calibrators associated with the card (such as in the kit with such controls or calibrators). The controls/calibrator card may be used in an analyzer with or without the other smart cards described herein.

A further type of smart card is referred to as a QC maintenance card which is placed in an analyzer while it is operating. The QC maintenance card is used by the analyzer to store QC maintenance information in the card's memory. Such information may be data representing results of daily QC runs of controls, date of recalibration, dates of cleaning, or other related information useful for maintenance of the analyzer. This card would be replaced once per month and sent to a central facility for “peer” proficiency comparisons. It also can be used by technical service to be certain that proper maintenance is being performed on an analyzer. The QC maintenance card may be used in an analyzer with or without the other smart cards described herein.

Although smart cards are referred to as having non-volatile memory, such cards may have electronics having logic circuitry (e.g., microprocessor-based) for enabling additional functionality typical of smart cards, such as encryption/decryption, or command/query based data access, if desired.

From the foregoing description, it will be apparent that there have been provided smart cards for an automated sample analyzer, an analyzer device for using smart cards, and a quality control kit. Variations and modifications in the herein described smart cards, device, kit, and method in accordance with the invention will undoubtedly suggest themselves to those skilled in the art. Accordingly, the foregoing description should be taken as illustrative and not in a limiting sense.

1. A smart card for use with device for automated analysis of samples taken from a patient in which said device has at least one slot interfacing said analyzer with a controller of said device, said smart card comprising:
a housing receivable in the slot of the device, said housing having memory and a connector for enabling the controller of the device to access said memory when said card is received in said slot of said device; and
said memory stores at least quality control information associated with one or more quality control samples, in which when said card is received in said slot of said device said controller accesses said memory to obtain said quality control information and uses said quality control information when any quality control samples associated with said quality control information are analyzed by said device to assure proper operation of said device.

2. The smart card according to claim 1 wherein said controller stores in said memory of the smart card one or more records of the results of analysis of quality control samples.

3. The smart card according to claim 1 wherein said quality control card must be received in said slot of said device to enable normal operation of said device.

4. The smart card according to claim 1 wherein said quality control information represents data representing at least the lot number of said quality control samples, acceptable ranges of results when said quality control samples are analyzed by said device, and expiration date of said quality control samples of said lot number.

5. The smart card according to claim 4 wherein said quality control information has multiple acceptable ranges of results at different times when said quality control samples are analyzed by said device.

6. The smart card according to claim 4 wherein said quality control information further represents data defining the number of days of quality control or number of quality control samples associated with said smart card.

7. The smart card according to claim 1 wherein said smart card represents one of a plurality of smart cards having information associated with one or more different lots of quality control samples.

8. The smart card according to claim 1 wherein said quality control information represents data representing at least an expiration date of said quality control samples associated with said card.

9. The smart card according to claim 8 wherein said controller detects when said quality control samples have expired in accordance with said data representing said expiration date.

10. The smart card according to claim 1 further comprising a first identifier stored in said memory of the smart card, said device having memory storing at least a second identifier, and said controller uses said quality control information from said card when said first identifier read from said card matches said second identifier stored in said device.

11. The smart card according to claim 2 wherein when said records of the results of analysis of quality control samples are stored in said memory of said card over a period of time, said card is removable from the device and said records are useable for proficiency testing of the device.

12. The smart card according to claim 2 wherein said controller further stores in said memory of the smart card an identifier uniquely identifying the device and the user of the device.

13. A quality control kit for an automated sample analyzer comprising:
at least one lot of quality control samples suitable for the analyzer; and
a card having memory storing quality control information for said quality control samples insertable in the analyzer.

14. The kit according to claim 13 further comprising a lot of normal samples having a normal acceptable range, and a lot of abnormal samples having an abnormal acceptable range, wherein said quality control information has at least said normal and abnormal acceptable ranges.

15. The kit according to claim 14 wherein said quality control information has the expiration date of said normal and abnormal samples.

16. The kit according to claim 14 wherein said quality control information has a lot number associated with said lot of normal samples and a lot number associated with said lot of abnormal samples.

17. The kit according to claim 14 wherein said quality control information has the number of days or number of samples of said normal and abnormal samples provided in said kit.

18. A system using smart cards with a device for automated analysis of samples comprising:
a plurality of cards each having memory storing at least one of information for enabling of setup of the device, setting the device for a lot of containers to hold samples to be analyzed, or quality control of said device in accordance with quality control sample; and
said information stored on each of said cards is accessible to said device when the card is received by said device.

19. The system according to claim 18 wherein each of said cards further stored a identifier associating said card with one of different types or models of said device for use by said device in determining when said card is proper for the device.

20. The system according to claim 18 wherein said each of said plurality of cards storing information for a lot of containers further stores at least a identifier associating said card with one of different types or models of said devices for use by the device in determining when containers associated with said card are proper for the device.

21. The system according to claim 18 wherein said each of said plurality of cards storing information for quality control further stores at least a identifier associating said card with one of different types or models of said devices for use by the device in determining when quality control samples associated with said card are proper for the device.

22. The system according to claim 18 wherein said each of said plurality of cards storing information for a lot of containers had at least data representing the expiration date of said containers, and said expiration date is utilized by the device in determining when said containers have expired.

23. The system according to claim 18 where each of said plurality of cards storing information for quality control stores at least data representing the expiration date of the quality control samples associated with the card, and said expiration date is utilized by the device in determining when said quality control sample have expired.

24. A device for automated analysis of samples taken from a patient comprising:
a controller controlling the operation of said device;
means for conducting an analysis of patient samples when located in said device to provide an output said analysis to said controller in which said controller produces results based on said analysis;
one or more quality control samples;
a card having memory storing quality control information for said quality control samples; and
means for interfacing said card to said controller, in which said controller uses said quality control information from said card when one or more quality control samples are analyzed by said conducting means to assure proper operation of said device.

25. A system using cards with at least one automated medical sample analysis device comprising:
a plurality of cards; and
each of said plurality of card has memory storing information accessible to the automated medical sample analysis device when received in said automated medical sample analysis device.

26. The system according to claim 25 wherein said information stored on one or more of said cards represents quality control information associated with quality control samples for use by said device in analysis of said quality control samples.

27. The system according to claim 26 wherein said device stores information in memory of at least one of said cards related to the results of quality control samples analyzed by the device.

28. The system according to claim 25 wherein said information stored on one or more of said cards represents information related to containers to hold samples for use by the device in setting said device to analyze a number of samples in accordance with the number of said information.

29. The system according to claim 25 wherein said information stored on one or more of said cards represents information for enabling one of setup of the device or updating software operating said device.

30. The system according to claim 25 wherein said information stored on one or more of said cards represents information related to the number of tests performable on the device.

31. The system according to claim 25 wherein said information stored on one or more of said cards represents information for calibrating the device in accordance with one or more controls or calibrators when analyzed by the device.

32. The system according to claim 25 wherein said memory of said card is used by the device for storing information for maintenance of the device.

33. The system according to claim 25 further comprising means for limiting said card for use with one of different types or models of said device.

34. A method for maintaining quality control of a device for automated analysis of samples comprising the steps of:
providing a card having memory storing quality control information for quality control samples;
interfacing said card with said device to enable said device to access said memory;
locating in said device one or more quality control samples associated with said quality control information; and
utilizing said quality control information obtained from memory of said card when said one or more quality control samples are analyzed by said device to determine whether or not said device is properly operating.
